(19) United States
(12) Patent Application Publication
(10) Pub. No.: US 2005/0179544 A1
(43) Pub. Date: Aug. 18, 2005

(54) Security system

(76) Inventors: Patrick Richard Sutton, Pembrokeshire (GB); Geoffrey Neil Goldsmith, Pembrokeshire (GB)

Correspondence Address: OPPEDAHL AND LARSON LLP, P O BOX 5068, DILLON, CO, 80435-5068, US

(21) Appl. No.: 10/512,123

(22) PCT Filed: Apr. 25, 2003
(86) PCT No.: PCT/GB03/01767

(30) Foreign Application Priority Data
Apr. 30, 2002 (GB) 0209824.2

(51) Int. Cl. E05B 45/06

(52) U.S. Cl. 340/543

(57) ABSTRACT

An electronic access control system comprising a lock cylinder and one or more user keys for use in operating the lock. Housed within the lock cylinder is a microprocessor and a memory. Each user key has an ID chip in which is embedded (at the time of manufacture) a unique ID number drawn from a pool of greater than 280,000,000,000,000 combinations, which number cannot be changed once it has been embedded in the key. A user key can be used to successfully open the lock if its unique ID number has been added to a list stored in the lock memory. The system further comprises an edit key which can be used to add or delete ID numbers of user keys from the list of valid keys stored in the lock memory.

This invention relates to a security system and, more particularly, to a security system comprising a mechanical lock and key and including an electronic access control facility to prevent unauthorised opening of the lock.

Electronic locks have a number of advantages over normal mechanical locks and many such electronic locks (or mechanical locks including an electronic access control facility) have been proposed in the past.

U.S. Pat. No. 5,552,777 describes a mechanical lock and key having an electronic access control feature for preventing opening of the lock, even with the proper mechanical key, unless prescribed conditions are met. The lock cylinder is fitted with a small ID or “serial number” chip which is read when a voltage is applied. The mechanical key has a key head with a battery, microprocessor and database. When the key is inserted into the lock, the lock conveys its ID to the microprocessor in the key, where it is compared against one or more stored ID's to determine if the key is authorised to open that lock and, if so, a signal or code is transmitted from the key to the lock allowing it to be opened; otherwise, the lock will not open. A record is made in the database (in the key) as to each instance of opening of each lock which the key fits.

PCT/US01/01531 describes a mechanical lock and key. The key comprises a housing in which is disposed a battery and a PCB. Mounted on the PCB is, among other things, a microprocessor. The lock includes a cylinder within which is mounted a PCB. Mounted on the PCB is, among other things, a lock processor and a memory. Electrical contact is made between the PCB in the key and the PCB in the lock when the key is inserted in the lock. In use, the key microprocessor and the lock microprocessor communicate with one another to allow the lock to be unlocked. Each key and lock has a unique identification code (stored in their respective microprocessors), which identification codes may be programmed in the respective microprocessors when the key or lock is manufactured. When a key engages a lock it sends power to the lock microprocessor. The lock microprocessor sends a signal corresponding to its identification code to the key microprocessor. The key microprocessor then sends a key identification code and a password to the lock microprocessor. The lock microprocessor determines whether the key identification code is authorised to open the lock. If so, the lock microprocessor sends a signal to the key microprocessor, which in response provides power from the battery to a solenoid in the lock mechanism to unlock the lock. Both the key microprocessor and the lock microprocessor may store within their respective associated memories activities occurring with respect to the key and lock. The key microprocessor and lock microprocessor are programmed (i.e. key identification codes and passwords can be added and deleted) by means of an external programming device such as a Palm Pilot™ or the like.

U.S. Pat. No. 5,367,295 describes a mechanical key and lock cylinder including an electronic access control feature. The key is fitted with a memory cell. The lock cylinder is provided with a processor board for processing data which is communicated thereto from the memory cell in the key via a connector unit in the cylinder. When the key is inserted into the lock cylinder, identification data stored in the memory cell is transmitted from the key to the processor board. The memory cell is programmable and password protected so that authorised persons can gain access to its contents to add/delete identification data as required. The identification data received from a key memory cell is compared by the processor board with authorised identification data and, if a match is found the lock will open.

GB-2291106-A describes an electronic key and a key reader (mounted in, for example, a keyhole or lock cylinder). The body of the key incorporates an electronic chip which, on activation, is capable of transmitting a stream of digital data through a two-wire contact in order to release or activate the lock, via a control system. The control system is housed within an external device plugged into the key reader. Thus, when the key is inserted into the key reader, a stream of digital data is transmitted through the two-wire contact to the key reader and then from the key reader to the above-mentioned external device. All communication to and from the system is carried out via the external control system. Keys are programmed using a separate key console or control computer.

U.S. Pat. No. 5,749,253 describes an electronic access control system. The access control system comprises a central host computer coupled to a plurality of door controllers disposed within respective door knobs or the like of doors required to be controlled. The doors themselves are locked by means of electromechanical locking apparatus, such as a solenoid mechanism to electrically actuate a mechanical locking system to remove or enable withdrawal of a latch, so that a door or other barrier to entry can be opened or accessed. The host computer continuously monitors the status of the door controllers to determine if there are any users at the doors. In the event that a user is detected (by insertion of a key), the host computer disables all door controllers in the security network and then enables each one in turn and checks for the existence of a key. If no key is detected, the controller is disabled again and the next one is enabled, and so on until the controller having a key inserted therein is identified. Once it has been identified, identification data is read from the key by the host computer and compared against a database containing lists of permitted keys for that particular controller. Only if there is a match, the host computer transmits a signal to actuate the solenoid and open the lock.

U.S. Pat. No. 5,974,367 describes an electronic lock and key arrangement in which three keys, namely a master key, an audit key and a service key, are provided for use in conjunction with the lock. When a key is inserted into the lock it supplies power to the lock and the lock responds with a request for key status. If a valid master key is inserted, the result is that a password is written from the master key to the electronic lock. When an audit key is inserted, the lock requests a password and, if the audit key provides a valid password, the lock transmits to the audit key first identification information. Finally, if a valid service key is inserted, it transmits second identification information to the electronic lock which causes the lock to be opened. Thus, the system requires the use of three keys, even though the master key and the audit key are unable to unlock the lock.

U.S. Pat. No. 6,000,609 describes an electromechanical lock and a key therefor. The lock cylinder includes (among other things) a microprocessor, a memory, a solenoid, and a battery. The microprocessor can be programmed as to authorised users, entry times, etc. using a special programming key, which itself is programmed by a computer. User keys have a memory cell or ID chip which is read by the microprocessor when a key is inserted into the lock and the lock will only open if all predetermined conditions for opening are met.

EP-A-0277432 describes an electronic lock and key system in which an electronically coded circuit is embedded in the handle of the key, and is arranged to transmit a predetermined digital code to an electrical terminal within the lock assembly, to enable the lock to be opened.

U.S. Pat. No. 5,140,317 describes an electronic security system comprising an electronic lock and an electronic key, each of which is provided with a microprocessor controller and a memory for storing data including an ID code. When a key is inserted in the lock, it transmits its ID code to the lock microprocessor controller, which compares the ID code against one or more stored ID codes and opens the lock only if a match is found. Further, the lock microprocessor changes the ID code stored in the key memory upon insertion of the key in the lock, such that the key can only be used to open the lock once, and must then be reprogrammed by a host computer with the updated ID code for the lock.

The systems and arrangements described above tend to suffer from one or more disadvantages including undue complexity and lack of versatility or adaptability to different lock configurations, as well as the requirement in many cases for a complex and expensive key management system to manage access to the lock. Furthermore, in all cases, the ID code required by the key to open the lock is programmed into the key memory and into the lock memory from an external source on a requirement basis. In other words, when a key is required to be authorised for use with a particular lock, an ID code is generated by an external programming device and programmed into the key memory and the lock memory. This process increases the complexity of the key management system and may leave the system vulnerable to a security breach.

We have now devised an improved electronic access control system which is effective, relatively simple, and versatile enough to be used in many different types of lock configuration.

Thus, in accordance with the present invention, there is provided an electronic access control system for application to a lock mechanism comprising a lock and one or more keys for operating said lock, said electronic access control system comprising first memory means disposed in or on said one or more keys, identification data which is unique to a respect key being stored in a non-changeable, non-deletable manner in said first memory means, the electronic access control system further comprising second memory means and processing means disposed in or on said lock for storing data representative of one or more keys authorised to operate said lock, for reading the identification data stored in or on a key which is applied to or inserted into said lock, and for causing said lock to operate only if the read identification data relates to a key authorised to operate said lock.

In a preferred embodiment the one or more keys authorised to operate said lock are selected from a pool of keys, each of which is provided with unique identification data, such as a unique ID number or the like.

Preferably, identification data representative of a key authorised to operate said lock may be read from the first memory means and stored in second memory means when that key is applied to or inserted into said lock. The second memory means and processing means may be arranged to operate in at least two selectable modes, an edit mode and a normal mode, wherein in the edit mode, identification data can be added to or deleted from the second memory means, and in the normal mode, the lock can be operated by the one or more authorised keys.

In one embodiment, one key of a set of keys associated with a particular lock is defined in the second memory means and processing means as an “edit key”, said edit key being arranged to cause the second memory means and processing means to operate in said edit mode. Preferably, the edit key causes the second memory means and processing means to enter the edit mode upon application or insertion thereof to the lock. Beneficially, the edit key is not configured to operate said lock.

Preferably, all identification data stored in the second memory means can be deleted by application or insertion of the edit key to the lock for a predetermined period of time.

In a preferred embodiment of the invention, in the edit mode, identification data associated with one or more keys authorised to operate the lock can be added to the second memory means by application or insertion to the lock of the respective one or more keys. In a more preferred embodiment, in the edit mode, if a key whose identification data is not stored in the second memory means is applied or inserted into the lock, the identification data is read and stored in the second memory means, and if a key whose identification data is stored in the second memory means is applied or inserted into the lock, the identification data is deleted from the second memory means.

Beneficially, one or more keys may each be provided with indicator means which is operated when a key applied or inserted into the lock is determined to be authorised to operate the lock.

Preferably, when it is determined that a key applied or inserted into the lock is authorised to operate the lock, the lock will remain operable for a predetermined period of time only, following which it is arranged to return to its inoperable state.

One or more additional memory means may be provided in or on the one or more keys, the or each additional memory means being arranged to store the unique identification data relating to another key. In this case, the system may comprise a key writing unit for copying the unique identification data relating to a first key (from the first memory means) to an additional memory means in or on a second key, the unique identification data relating to the second key remaining in its respective first memory means. Further, in a preferred embodiment, when a key is applied or inserted into the lock, the processing means determines if the unique identification data relating to said key is stored in the second memory means, if so it causes the lock to operate, if not, it determines if any additional identification data is stored in the one or more additional storage means, if so, it determines if the additional data is stored in the second memory means, and if so, it causes the lock to operate.

The present invention extends to a method of providing an electronic access control system for application to a lock mechanism comprising a lock and one or more keys for operating said lock, said method comprising the steps of providing a plurality of keys in or on each of which is stored unique identification data in a non-changeable, non-deletable manner, selecting one or more of said plurality of keys and storing the unique identification data relating to the or each selected key of one or more keys in memory means provided in or on said lock, reading the identification data stored in or on a key which is applied to or inserted into said lock, causing said lock to operate only if the read identification data relates to a key authorised to operate said lock.

A specific embodiment of the present invention will now be described byway of example only and with reference to the accompanying drawings, in which:

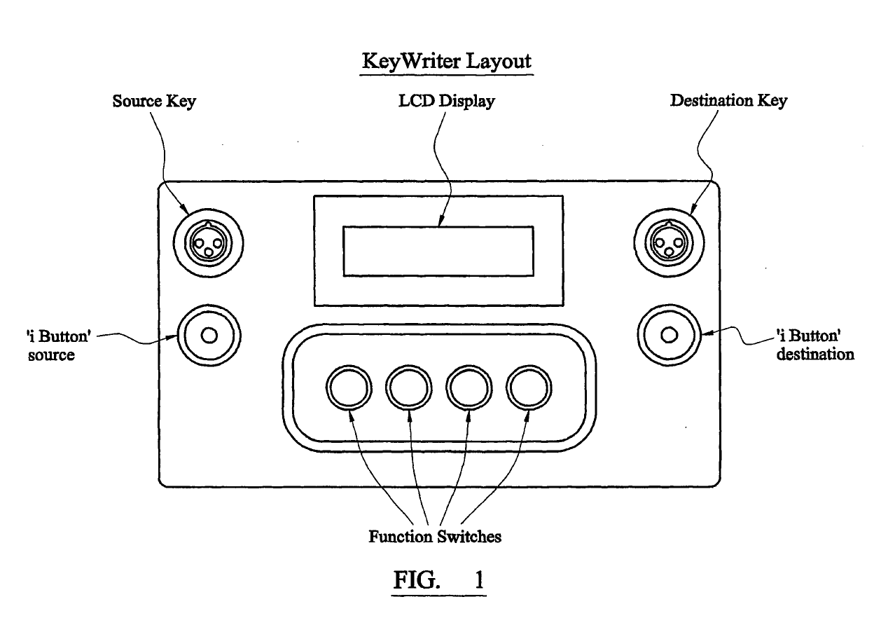

FIG. 1 is a schematic diagram illustrating the layout of a keywriter for use with an exemplary embodiment of the present invention; and

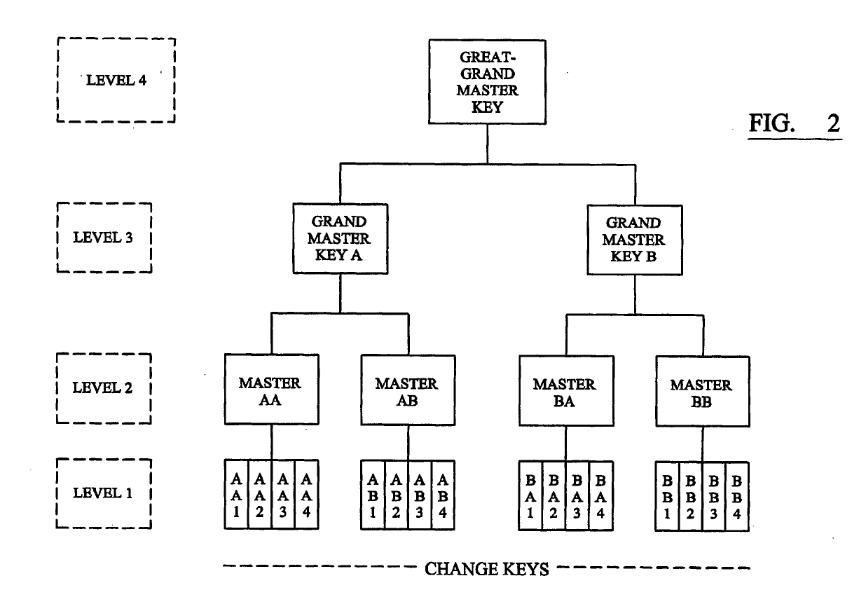

FIG. 2 is a schematic diagram of a four-level keying system which illustrates an electronic access control system according to an exemplary embodiment of the present invention.

The electronic access control system of an exemplary embodiment of the present invention comprises a lock cylinder and one or more user keys for use in operating the lock. Housed within the lock cylinder is a microprocessor and a memory. Each user key has an ID chip in which is embedded (at the time of manufacture of that chip) a unique ID number drawn from a pool of greater than 280,000,000,000,000 combinations, which number cannot be changed once it has been embedded in the key. The user key may also be provided with additional storage locations. A user key can be used to successfully open the lock if its unique ID number or a secondary number stored in one of the key's additional storage locations (to be described later)has been added to a list stored in the lock memory.

The system further comprises an edit key which can be used to add or delete ID numbers of user keys from the list of valid keys stored in the lock memory. In general, it is preferred that only one key be defined as the edit key for each cylinder, although under some circumstances, a single edit key may be defined for use with several different cylinders. It will be appreciated that the edit key cannot be used to operate the lock; its function is solely to enable the contents of the lock memory to be edited.

The edit key may be used to clear the user key list stored in the lock memory. This is achieved by inserting the edit key in the lock and holding it there for a predetermined period of time, say twenty seconds. The lock microprocessor identifies the insertion of the edit key for the predetermined period of time, and clears or deletes the list of authorised user keys from the lock memory. It will be appreciated that, since the edit key is not configured to activate the lock and it cannot rotate the inner section of the cylinder, it must be held in the cylinder for the predetermined period of time as it will not be retained by the cylinder. In a preferred embodiment, the edit key is provided with a light emitting diode (LED) which goes on when the edit key is inserted in the cylinder and goes off when it is removed or when the predetermined period of time has elapsed indicating that the user key list stored in the lock memory has been cleared.

Once the lock memory has been cleared, one or more new user keys will have to be added before the lock can be used. A mode in which the lock memory can be edited, i.e. user keys can be added or selectively deleted from the lock memory, hereinafter referred to as the “cylinder edit mode”, may be entered by removing the edit key from the cylinder before the above-mentioned predetermined time has elapsed, i.e. before the edit key LED goes off. If it is not required to edit the lock memory, i.e. the edit key has been inserted into the cylinder by mistake, removing the key and then re-inserting it into the cylinder will restore normal operation (“normal mode”), and is indicated by the edit key LED flashing on once.

In order to add a user key to the lock memory, it is first necessary to enter the cylinder edit mode as described above, in which mode simply inserting a previously unlisted user key into the cylinder and then removing it will add that user key to the list of authorised user keys stored in the lock memory. In other words, when a user key is inserted into the cylinder during the cylinder edit mode, the lock processor reads the unique ID number embedded in the user key memory and, if that ID number is not already stored in the lock memory, it is added thereto. In a preferred embodiment, the user keys are provided with a light emitting diode (LED) or the like and, in order to indicate that a previously unlisted user key has been added to the lock memory, the LED may be arranged to go on for a predetermined period of time, say two seconds, and then go off. The cylinder may also be unlocked for that predetermined period of time as a further indicator of a successful addition. Further previously unlisted user keys may be added to the lock memory in the same manner, perhaps up to a predetermined maximum of say 18 or 20 keys per cylinder.

Once all the required user keys have been added to the lock memory, the cylinder edit mode may be terminated by inserting the edit key into the cylinder again and then removing it, thereby returning the mode of operation of the cylinder to normal mode (indicated by the edit key LED flashing on once) as described above.

In order to delete a user key from the lock memory, the cylinder edit mode must first be entered, as described above. The listed user key to be deleted from the lock memory may then be inserted into the cylinder to delete it from the lock memory. In other words, when a user key is inserted into the cylinder during the cylinder edit mode, the lock processor reads the unique ID number embedded in the user key memory and, if that ID number is already stored in the lock memory, it is deleted therefrom. A successful deletion may once again be indicated by the user key LED flashing on once. Further user keys may be deleted from the lock memory in the same manner and, when all required keys have been deleted, cylinder edit mode can be terminated as described above.

Once a user key ID number has been added to the list of ID numbers stored in the lock memory, that user key can be used to operate the lock cylinder. When the user key is placed on the cylinder receptacle, the cylinder processor reads the ID number embedded therein and, if it matches an ID number stored in the lock memory, the cylinder is unlocked (perhaps, for example, because power is caused to be supplied to the solenoid forming part of one particular type of lock mechanism) and free to rotate. The system may be arranged such that, when an authorised user key is inserted into the cylinder, the cylinder is only unlocked for a predetermined period of time, say 1.5 seconds, irrespective of how long the key is actually in the lock. Thus, when an authorised user key is inserted, the cylinder is unlocked for 1.5 seconds and the inner section of the cylinder is free to rotate so that the lock can be opened. The inner section of the cylinder is free to rotate in any direction and through as many cycles as required while the cylinder is unlocked. The direction and angle of rotation will, of course, be dictated by the particular lock mechanism into which the cylinder is inserted.

This period during which the cylinder is unlocked may be indicated by the user key LED going on and remaining on for the duration of the period during which the cylinder is unlocked, and then going off to indicate that the cylinder is locked once again.

In one specific embodiment of the invention, as the key starts to rotate the inner section of the cylinder, an outer channel in the receptacle engages with a lug on the key and prevents the removal of the key until it is returned to the starting position. Of course, the period during which the cylinder is unlocked may expire before it is returned to its starting position, in which case the mechanical layout of the cylinder may be such the key may continue to rotate the cylinder until it returns to the point where the key may be removed. At this point the mechanism will prevent any further rotation.

In the event that a user key which is not listed in the lock memory is inserted into the cylinder, this is determined by the cylinder processor and the cylinder will remain locked, i.e. the key will not be able to rotate the inner section of the cylinder. This may be indicated by the user key LED flashing on and off for a predetermined period of time

Thus, in the basic system described above, an edit key and the required user keys are used to add and delete user key ID numbers from the lock memory. However, if a key is lost or stolen, such that it is not available for use to delete its ID number from the lock memory, the only way in which it can be deleted from the lock memory is to clear the entire lock memory and re-enter the ID numbers of the required user keys using the procedure described above. This is not particularly problematic when only a small number of user keys are involved, but as the list grows so does the inconvenience of this approach. At this stage, a PC-based key management system could be employed (as in many of the prior art systems) whereby the ID numbers of the required keys may be entered into the lock memory via a PC rather than by using the keys themselves. However, it is much more advantageous to provide a simpler, non PC-based system which can be used with the system described above to ease the task of key management. The second aspect of the present invention is primarily concerned with such a system.

Thus, in the basic system described above, the number of user keys which may be used with each cylinder may be limited (either physically or practically) to say 18 or 20. However, the second aspect of the present invention is concerned with the expansion of the basic system to allow a larger, or unlimited, number of user keys to be used with any one cylinder, whilst still employing the basic key management function provided within the cylinder as described above.

This aspect of the present invention employs a user key having its ‘primary’ ID number embedded therein, as described above, and also having one or more additional storage locations which can be loaded with a ‘secondary’ number shared by other user keys. For the purposes of this description, a user key having only a primary ID number embedded therein (and no secondary ID number) will be referred to as a primary user key, and a user key having both a primary ID number and a secondary ID number will be referred to as a secondary user number.

In this exemplary embodiment of the present invention, both the edit key and the user keys have storage locations in addition to their primary ID number. It will be appreciated that the edit keys and the user keys are substantially identical—it is the internal list of keys stored in the lock memory which defines the function of any particular key.

The primary number location contains the key's unique primary ID number. This number is fixed and may not be altered at any time. As such it provides a unique identifier for its respective key.

Each key may also have (say) four secondary number locations which can be loaded with up to four secondary ID numbers. A secondary number is essentially a copy of another key's primary ID number and can be changed by a “keywriter” (to be described below). A user key having a secondary ID number which is included in the list of authorised key numbers stored in the lock memory can be used to unlock the cylinder. Thus, secondary numbers allow copies of user keys to be made, thereby allowing any one cylinder to be operated by a large pool of keys. In the case where the number of user key ID numbers which can be stored in the lock memory is limited to, for example, 18 or 20, up to 18 or 20 sets of user keys can be used with each cylinder. However, for security reasons, it is preferred that only the primary ID number of a user key ,may be used in conjunction with the edit key in order to modify the key list stored in the lock memory.

Each key may also be provided with an additional secure storage location which may be reused until it is “locked”, in which state the memory may only be read. This additional storage location may be used to store extra security key numbers.

Thus, the secondary number(s) to be stored in a user key is read from a selected user key's primary number and loaded into the secondary number storage location of the user key by a ‘keywriter’. This process is preferably made more secure by only allowing a user key's primary ID number to be copied—no key's secondary number(s) can be copied—such that in order to make a copy of a key, it is necessary to be in possession of the original. In this case, it is preferred that only secondary user keys be used to operate the lock, with the primary user key(s) and the edit key being kept in a secure location for use only by authorised persons for the purposes of duplication of keys and deletion of user key numbers from the lock memory. Further, in this preferred embodiment of the invention, the edit key only uses its primary ID number as its identification and cannot be copied, and secondary user keys cannot be used in conjunction with the edit key in order to add or delete keys from the cylinder list.

When the cylinder processor reads a key, it first reads the key's unique primary ID number and tries to match it with its stored list. If this number matches the edit key's unique primary number, it will enter either the cylinder edit mode or exit it, depending on its previous state. If the unique primary ID number matches one of its stored user key numbers, it will either operate the cylinder (in normal mode) or delete that key number from the lock memory (in cylinder edit mode).

On the other hand, if no match is found for the unique primary ID number and the cylinder is cylinder edit mode, it will add that key number to the list of user key numbers stored in the lock memory. If the cylinder is not in cylinder edit mode, the cylinder will then look for the key's secondary ID number(s). If it finds such a number, it will try to match it to the list of user keys stored in the lock memory and, if a match is found, it will operate the cylinder. In the event that no secondary ID number(s) are found or none such numbers match any of the user keys stored in the lock memory, the key will be rejected and the cylinder will remain locked.

The above-mentioned keywriter will now be described in more detail. The keywriter according to this exemplary embodiment of the present invention consists of a box with two key receptacles, one, or more preferably two, Dallas iButton receptacles, a sounder (optional), a liquid crystal display (LCD) and four button switches. The layout of this exemplary keywriter is illustrated in FIG. 1 of the drawings. One of the key receptacles (in this case, the left-hand key receptacle) and at least one of the Dallas iButton receptacles are used for the primary key source contact, and the right-hand key receptacle is used for the destination secondary key contact. The provision of two Dallas iButton receptacles enables the keywriter to read and write iButtons.

Dallas iButtons are stainless steel cans that resemble button cell batteries but contain the same chip as is within the keys. These buttons are robust and relatively inexpensive and do not require a battery, so they are considered well suited for use as sources of the primary ID numbers. For security reasons, such buttons can only be used, in conjunction with the keywriter because they would not be able to interface directly with and therefore operate the cylinder.

A button switch may be provided which is pressed to initiate an operation and the LCD and optional sounder are used to communicate the result of that operation. Power for the keywriter is provided by the primary or secondary user keys being used.

Operation of this exemplary embodiment of the key writer will now be described in more detail. As stated above, the keywriter may be used to make copies of keys for use with a lock processor. The version described below may be supplied for use with a replacement lock.

In order to copy the unique primary ID number of a key to a secondary location of another key, the primary user key or Dallas iButton is inserted into one of the left-hand receptacles of the keywriter. The key to be written to is inserted into the right-hand receptacle. Upon pressing the button switch, the primary ID number of the left-hand user key will be copied to a secondary storage location of the right-hand user key. In this exemplary embodiment of the present invention, up to four secondary storage locations in a single key may written to in this way. If all of the secondary storage locations on the key being written to are full, this fact will be indicated on the LCD.

In order to remove a secondary ID number from a key, the key in question is inserted into the right-hand receptacle and each of the secondary storage locations are displayed in turn on the LCD by pressing the button switch, such that a selected location can be cleared as required.

In more detail, in order to write a number to the destination key, place the source of the Primary Number onto the source receptacle and the destination key whose Secondary location is to be written to in the destination receptacle. If the source of the Primary number is a key with a charged battery, the Keywriter will power-up. If the source is an iButton, then the Keywriter will not power-up until the destination key is placed onto the destination receptacle. When the Keywriter powers-up and if the Primary Number of the source device has been read successfully, the following display will appear.

SRC=123456789ABC

1=CONT 2-CHECK#

Note# is the battery level symbol, this will show empty for an iButton. 123456789ABC represents the number that has been read.

This display shows the Primary Number of the source key and its battery level. If the source key is either not present or has not been read successfully the following display will appear

NO SOURCE KEY

1=CONT 2=CHECK#

In this case the key may be read again by pressing button 2 until it is read successfully. When the source Primary number has been read successfully, press button 1 to continue. If the following display appears

NO DEST KEY

1=CONT 2-CHECK#

This means that the destination key has not been detected. Press button 2 to check again. When the destination key has been detected, the following display will appear

01=CLEAR

1ADD 2CLR 3NXT#

This display shows that Secondary Location 01 of the destination key is clear and may be written to. If the following display appears

01=CBA987654321

1ADD 2CLR 3NXT#

Note CBA987654321 represents the Secondary Number that has been read.

This shows that the Secondary Location 01 already contains a number. If button 2 is now pressed this location will be cleared and the following display will appear

01=CLEAR

1ADD 2CLR 3NXT#

If button 1 is pressed, Secondary Location 01 will have the Primary Number of the source key written to it and the following display will appear

01=123456789ABC

1ADD 2CLR 3NXT#

Note 123456789ABC represents the source key's Primary Number that has been written into Secondary Location 01 in the destination key.

Pressing button 3 at this point will cause the Keywriter to read the next Secondary location. The following display will appear

02=DCBA98765432

1ADD 2CLR 3NXT#

if the Secondary Location 02 contains a number (represented by DCBA98765432), or the following

02=CLEAR

1 ADD 2CLR 3NXT#

if the location is clear. Pressing button 3 again will show the contents of Secondary Location 03, and pressing it again will show the contents of Secondary Location 04. At each of these stages, the displayed Secondary Location may be written to (press button 1), cleared (press button 2) or left unaltered by pressing button 3 and moving the display to the next Secondary Location. Secondary Locations do not have to be cleared before they are written to; pressing button 1 while the displayed Secondary Location is not clear will cause that location to be overwritten by the source key's Primary Number.

Pressing button 3 whilst Secondary Location 04 is being displayed, will cause the Keywriter to go back to the initial display of

SRC=123456789ABC

1=CONT 2=CHECK#

if the source key is still present, or

NO SOURCE KEY

1=CONT 2=CHECK#

if the source key has been removed.

In order to add further numbers to the destination key's Secondary Locations, a new source key's Primary Number may be read and displayed, and then this may be added to the selected destination key's Secondary Location by stepping through the displayed Secondary Locations by pressing button 3, until the required location is displayed. Pressing button 1 at this point will write the source number to this location.

If the destination key needs to be cleared and no numbers loaded into it, then this can be done without the need to place a source key in the Keywriter. This is done as follows

With no keys in the Keywriter and with the Keywriter powered-down, place the key to be cleared in the destination key receptacle. If the key's battery is charged, the following display will appear

NO SOURCE KEY

1=CONT 2=CHECK#.

Press button 1 and the following display will appear

01=CBA987654321

1ADD 2CLR 3NXT#

Pressing button 2 will clear this location and the following display will appear

01=CLEAR

1ADD 2CLR 3NXT#

All the locations may be cleared, by using button 3 to move to the next location to be cleared.

Pressing button 3 when Secondary Location 04 is displayed, will bring the display back to the initial display of

NO SOURCE KEY

1CONT 2=CHECK#

The key may be removed at any time to halt the procedure.

As in the case of clearing the Secondary Locations, the source key does not need to be present in order to view the Secondary Locations of a key. This may be done as follows

With no keys in the Keywriter and with the Keywriter powered-down, place the key to be viewed in the destination key receptacle. If the key's battery is charged, the following display will appear

NO SOURCE KEY

1=CONT 2=CHECK#

Press button 1 and the following display will appear

01-CBA987654321

1ADD 2CLR 3NXT#

or

01=CLEAR

1ADD 2CLR 3NXT#

Pressing button 3 will cause the next Secondary Location to be displayed

02=DCBA98765432

1ADD 2CLR 3NXT#

or

02=CLEAR

1ADD 2CLR 3NXT#

Pressing button 3 when Secondary Location 04 is displayed, will bring the display back to the initial display of

NO SOURCE KEY

1=CONT 2=CHECK#

The key may be removed at any time to halt the procedure.

As stated above, the cylinder processor recognises an edit key by using its primary ID number only, such that the keywriter cannot be used to make copies of the edit key. However, in this exemplary embodiment of the present invention, the secondary storage locations in the edit key (which is physically identical in every way to the user keys and is only distinguished therefrom by its definition within the cylinder processor) have a special function in that the keywriter can be used to load ID numbers from other keys into these locations and these numbers can be transferred from the edit key to the lock memory. In other words, the edit key can be used as a carrier of key numbers. It will be appreciated that, in this exemplary embodiment of the invention, only the edit key can do this because the cylinder processor recognises it by its primary ID number only.

The cylinder treats these secondary numbers stored on the edit key in the same manner as if it were being presented with the respective primary (during edit mode), if a secondary number stored thereon is not present in the list stored in the lock memory, that number is added to the list. If the number is already present in the list, it is deleted therefrom. As before, additional primary user key numbers may be added to the list while the cylinder is still in edit mode. Edit mode is terminated by removing the edit key and then touching it to the cylinder again, in response to which the edit key LED will flash once as described above.

The above-described method and apparatus has a number of advantages:
The same key hardware can be used for edit keys, primary user keys and secondary user keys.
The basic system using only primary user keys, without the keywriting hardware, permits a very low-cost entry-level system
This entry-level system can be expanded at any time by the use of a keywriter
The use of duplicated secondary numbers in the secondary user keys does not preclude the use of audit trail software (i.e. software for recording details of each use of a key in a lock) because each key still has its own unique primary ID number.

The simplest key and cylinder system would consist of an Edit Key and one Primary User Key. This system could be expanded by the user to add more Primary User Keys for the cylinder up to a maximum of 20 Primary User Keys. There would not be a Keywriter and so all the keys would be using their unique Primary Numbers to active the cylinder; loss of a

Primary User Key would require the re-entering of the cylinder's key list in order to exclude the lost key.

Additional cylinders could be added to the system and could use a completely different set of keys or have some shared keys or all keys shared.

Whilst this approach allows the simplest of cylinder and key arrangements to be configured without the need for additional PC-based software (therefore minimising the entry cost for the system), further expansion to complex master keying is also possible.

Consider the complex four-level keying system illustrated in FIG. 2 of the drawings. This may be accomplished using the cylinder as follows:

For this illustration the unique Primary Numbers of the keys, will be represented by letters and the Edit Key, will be represented by the letters “ED”. The Great Grand Master may operate all the cylinders in the complete set. In order to accomplish this, its number (GGM) must be present in the key lists of all the cylinders in the set. For the Grand Master Key A, its number (GMA) must be present in all cylinders of the “A” set. For the Master AA, its number (MAA) must be present in all the cylinders of the “AA” subset. For the AA change keys, their number (AA1, AA2 etc) need only be present in the cylinder that they are to operate.

Thus the key list within the cylinder operated by change key AA1 would look as follows:

| | |
|---|---|
| Edit Key | ED |
| User Key 1 | GGM |
| User Key 2 | GMA |
| User Key 3 | MAA |
| User Key 4 | AA1 |

Note that the User Keys may be in any order in the cylinder's key list, their function i.e. Master, Grand Master etc. is dictated by the number of Edit Key lists in which they appear.

Thus the key list within the cylinder operated by change key AA3 could look as follows:

| | |
|---|---|
| Edit Key | ED |
| User Key 1 | MAA |
| User Key 2 | GMA |
| User Key 3 | AA3 |
| User Key 4 | GGM |

Using the notation developed above, it can be seen that the cylinder activated by change key AB3 would look as follows:

| | |
|---|---|
| Edit Key | ED |
| User Key 1 | GGM |
| User Key 2 | GMA |
| User Key 3 | MAB |
| User Key 4 | AB3 |

and that activated by change key BB4 would look as follows:

| | |
|---|---|
| Edit Key | ED |
| User Key 1 | GGM |
| User Key 2 | GMB |
| User Key 3 | MBB |
| User Key 4 | BB4 |

Up to (say) 17 change keys could be allocated to each cylinder at level 1; three User Key locations within the cylinder's list, would be taken by the key numbers for the Great Grand Master, Grand Master and Master for the set. The loss of a key within the set would necessitate the re-loading of the key numbers within the cylinders. The number of cylinders requiring the update would increase the higher the level of the key that was lost. Loss of the Great Grand Master would require the re-loading of all of the cylinders in the set.

As the complexity of the system increases, the wisdom of using Secondary User Keys in the field, whilst keeping the Primary User Keys secure, increases. If Secondary User Keys were used in the field for the Master Keys, then possession of the Primary User Key would allow a key's removal from the cylinder without having to re-load all the other keys. Change keys could be Primary User Keys as their loss only affects one cylinder, although as the number of change keys increases so does the inconvenience of having to re-enter the whole list.

Cross Keying

Cross keying of the cylinders can be accomplished by having the number of a change key present in a number of cylinders. If complex cross keying were to be employed, then it would make sense to use Secondary User Keys as the loss of a cross key could affect a number of cylinders.

Dealing with Large Numbers of Change Keys

In situations where a lock cylinder needs to be activated by a large number of change keys i.e. the front door to a building, this can be achieved by using the Keywriter to produce a large pool of Secondary User Keys. Should a key be lost, the original key containing the Primary Number could be used to remove the key number from the cylinder's key list. New keys could then be issued by writing new Secondary Numbers to the Secondary Keys.

In the master-keying example given above, there is space in the Edit Key list for up to 17 different change keys. In a very large installation, where many change keys are to be issued to operate the cylinder, each of these individual change keys may represent a large pool of Secondary User Keys. Thus if a key was lost, only those Secondary User Keys within the same group of keys would need to be altered.

Thus, the system of the present invention is intended to meet the needs of a user who does not want the overhead of a key management system in order to gain the advantages of an electronic lock. The system may be used in a variety of lock systems, although to illustrate its flexibility, it has been described above for use in a replacement lock cylinder. The advantage of the basic system described above is the easy re-keying of the lock processor and the use of keys which have a unique serial number drawn from a pool of greater than 280,000,000,000,000 combinations. This basic system can be expanded, thereby further increasing the versatility of the system, by the use of a keywriter as described above. The system maintains a high level of security because the list of keys which can operate a cylinder is only kept within the cylinder, and at no time will the lock processor release the serial numbers of valid keys in its list. Although a user could find out the serial number of a key using the keywriter, the user does not need to know its number in order to use it.

Although a specific exemplary embodiment of the present invention has been described above, it will be appreciated by a person skilled in the art that modifications and variations can be made to the described embodiment without departing from the scope of the invention as defined in the appended claims.

1. An electronic access control system for application to a lock mechanism comprising a lock and one or more keys for operating said lock, said electronic access control system comprising first memory means disposed in or on said one or more keys, identification data which is unique to a respective key being stored in a non-changeable, non-deletable manner in said first memory means, the electronic access control system further comprising second memory means and processing means disposed in or on said lock for storing data representative of one or more keys authorised to operate said lock, for reading the identification data stored in or on a key which is applied to or inserted into said lock, and for causing said lock to operate only if the read identification data relates to a key authorised to operate said lock.

2. An electronic access control system according to claim 1, wherein the one or more keys authorised to operate said lock are selected from a pool of keys, each of which is provided with unique identification data.

3. An electronic access control system according to claim 1, wherein identification data representative of a key authorised to operate said lock may be read from said first memory means and stored in said second memory means when said key is applied to or inserted into said lock.

4. An electronic access control system according to claim 3, wherein said second memory means and processing means are arranged to operate in at least two selectable modes, an edit mode and a normal mode, wherein in said edit mode, identification data can be added to or deleted from said second memory means,and in said normal mode, said lock can be operated by said one or more authorised keys.

5. An electronic access control system according to claim 4, wherein one key of a set of keys associated with a particular lock is defined in said second memory means and processing means as an ‘edit key’, said edit key being arranged to cause said second memory means and processing means to operate in said edit mode.

6. An electronic access control system according to claim 5, wherein said edit key causes said second memory means and processing means to enter said edit mode upon application or insertion thereof to said lock.

7. An electronic access control system according to claim 5, wherein said edit key is not configured to operate said lock.

8. An electronic access control system according to claim 5, wherein all identification data stored in said second memory means can be deleted by application or insertion of said edit key to said lock for a predetermined period of time.

9. An electronic access control system according to claim 5, wherein in said edit mode, identification data associated with one or more keys authorised to operate said lock can be added to or deleted from said second memory means by application or insertion to said lock of said respective one or more keys, and/or wherein in said edit mode, identification data associated with one or more keys authorised to operate said lock can be added to or deleted from said second memory means by application or insertion to said lock of said edit key.

10. An electronic access control system according to claim 9, wherein in said edit mode, if a key whose identification data is not stored in said second memory means is applied or inserted into said lock, said identification data is read and stored in said second memory means, and if a key whose identification data is stored in said second memory means is applied or inserted into said lock, said identification data is deleted from said second memory means.

11. An electronic access control system according to claim 1, wherein said one or more keys is or are each provided with indicator means which is operated when a key applied or inserted into said lock is determined to be authorised to operate said lock.

12. An electronic access control system according to claim 1, wherein when it is determined that a key applied or inserted into said lock is authorised to operate said lock, the lock will remain operable for a predetermined period of time only, following which it is arranged to return to its inoperable state.

13. An electronic access control system according to claim 1, wherein one or more additional memory means are provided in or on said one or more keys, the or each additional memory means being arranged to store the unique identification data relating to another key.

14. An electronic access control system according to claim 13, comprising a key writing unit for copying the unique identification data relating to a first key (from said first memory means) to an additional memory means in or on a second key, the unique identification data relating to said second key remaining in its respective first memory means.

15. An electronic access control system according to claim 13, wherein when a key is applied or inserted into said lock, the processing means determines if the unique identification data relating to said key is stored in said second memory means, if so, it causes said lock to operate, if not, it determines if any additional identification data is stored in said one or more additional storage means, if so, it determines if said additional data is stored in said second memory means, and if so, it causes said lock to operate.

16. (canceled)

17. A method of providing an electronic access control system for application to a lock mechanism comprising a lock and one or more keys for operating said lock, said method comprising the steps of providing a plurality of keys in or on each of which is stored unique identification data in a non-changeable, non-deletable manner, selecting one or more of said plurality of keys and storing the unique identification data relating to the or each selected key of one or more keys in memory means provided in or on said lock, reading the identification data stored in or on a key which is applied to or inserted into said lock, causing said lock to operate only if the read identification data relates to a key authorised to operate said lock.

18. (canceled)
